(19) United States
(12) Patent Application Publication
(10) Pub. No.: US 2024/0192021 A1
(43) Pub. Date: Jun. 13, 2024

(54) Handling Road Marking Changes

(71) Applicant: ARGO AI, LLC, Pittsburgh, PA (US)

(72) Inventors: Konstantinos BATSOS, Santa Clara, CA (US); Khalid Yousif, Milpitas, CA (US); Thomas Bu, Pittsburgh, PA (US); Yong-Dian Jian, Pittsburgh, PA (US)

(73) Assignee: ARGO AI, LLC, Pittsburgh, PA (US)

(21) Appl. No.: 18/077,646

(22) Filed: Dec. 8, 2022

(51) Int. Cl. G01C 21/00; G06N 3/045; G06N 3/08

(52) U.S. Cl. CPC G01C 21/3822; G01C 21/3841; G06N 3/045; G06N 3/08

(57) ABSTRACT

Disclosed herein are system, method, and computer program product embodiments for handling changes in road markings. For example, the method includes identifying a road marking in a road trajectory of a vehicle using an artificial intelligence (AI) model and sensor data from a sensor of the vehicle and performing a map update based on a determination that there is a change in road markings in the road trajectory. The determination is based on at least on-board data generated when the vehicle is traversing the road trajectory and off-board data generated using stored data. The sensor data includes two or more sensor modalities.

### BACKGROUND

Autonomous vehicles (AVs) rely on maps to navigate in a real-word environment during operation. A map may be a set of digital files including data identifying physical details of a geographic area such as roads, lanes within roads, traffic signals and signs, and road surface markings. The map may be generated using images of the surroundings captured by vehicles equipped with sensors such as light detection and ranging system (LiDAR), cameras, radar, and the like. An AV may receive the map before operation. The AV may use the map to augment the information that the AV's on-board perception system (e.g., cameras, LiDAR system) perceive.

In general, contents of the received map are static until the AVs download/receive an updated map. Map changes can occur due to new road constructions, repainting of roads, construction projects that may result in temporary lane changes and/or detours. Maps can change several times per day. For example, a new road marking (e.g., turn right only sign) may be painted on a road surface and the change is not reflected on the map. Thus, the maps are no longer accurate and cannot be relied on.

### SUMMARY

In some aspects, a method includes identifying, by one or more computing devices, a road marking in a road trajectory of a vehicle using an artificial intelligence (AI) model and sensor data from a sensor of the vehicle, and performing a map update based on a determination that there is a change in road markings in the road trajectory. The determination is based on at least on-board data generated when the vehicle is traversing the road trajectory and off-board data generated using stored data. The sensor data includes two or more sensor modalities.

In some aspects, a system includes at least one processor coupled to the memory. The at least one processor is configured to identify a road marking in a road trajectory of a vehicle using an artificial intelligence (AI) model and sensor data from a sensor of the vehicle and perform a map update based on a determination that there is a change in road markings in the road trajectory. The sensor data includes two or more sensor modalities. The determination is based on at least on-board data generated when the vehicle is traversing the road trajectory and off-board data generated using stored data

### BRIEF DESCRIPTION OF THE DRAWINGS

The accompanying drawings are incorporated herein and form a part of the specification.

FIG. 1 illustrates an exemplary autonomous vehicle system, in accordance with aspects of the disclosure.

FIG. 2 illustrates an exemplary architecture for a vehicle, in accordance with aspects of the disclosure.

FIG. 3 is a block diagram that illustrates an example control flow of a system for detecting and handling changes in road markings, in accordance with aspects of the disclosure.

FIG. 4 is a block diagram of an artificial intelligence model for detecting changes in road markings, in accordance with aspects of the disclosure.

FIGS. 5A-5E are schematics that illustrate changes in road markings, in accordance with aspects of the disclosure.

FIG. 6 is a flowchart for a method for detecting and handling changes in road markings, in accordance with aspects of the disclosure.

FIG. 7 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for detecting and handling changes in road markings.

An autonomous vehicle (AV) may rely on a map (e.g., a base map, an a priori map, an a priori high definition (HD) map) of an operating area. The map may refer to a pre-generated map that is downloaded onto the AV and is used by the AV to help navigate its surroundings. The map may include information associated with the operating area. For example, the map may specify a geometry of a drivable area and lane markings, lane marking types, a direction of a lane, a speed limit associated with the lane, and traffic controls including traffic signs and traffic signals.

The map reduces the burden on an autonomous software of the AV to construct an accurate model of its environment. However, sometimes the map is (or becomes) inaccurate. Sometimes, the AV may encounter changes in road markings (e.g., lane dividers, turn arrows, crosswalks, bike lanes). The AV may detect road markings on an area that the AV is currently traversing and may compare the detected road markings to the map that is built offline using historical data. Thus, to detect changes in the road markings, the base map and an on-board task are used.

In some approaches, an off-board road marking raster is generated based on the intensities of as light detection and ranging (LiDAR) points classified as ground using the off-board data. Thus, the offline task (also referred to herein as off-board task) generates a bird eye view of the LiDAR intensities. The on-board task generates an on-board road marking by accumulating LiDAR intensities of the area the vehicle is traversing. The on-board raster is calibrated to the off-board raster (e.g., coordinates may be calibrated). Then, the two rasters are compared. However, this approach suffers when using data from different types of LiDAR sensors and/or mixing from different time intervals. In addition, a LiDAR intensity channel may have a weak response when the road is wet/snowy. The LiDAR intensity might change due to the repainting of the road markings. Thus, a false positive rate may increase as the repainting may be falsely classified as a change in the road markings. Further, difference in seasons (i.e., off-board data are collected in a different season from the on-board data) may affect the detection of the road markings. For example, leaves on a side of the road during fall season may affect the road marking detection (e.g., side line may be hidden by the leaves). The intensity of the LiDAR is a function of the reflectivity, a range, and an incident angle that makes the intensity hard to accurately estimate as a variation in one of the reflectivity, the range, or the incident angle may alter the detected intensity which in turn affects the detectability of the road markings.

In some embodiments, a multimodal approach is used to identify the changes that overcomes the above challenges. Changes in road markings are handled through dynamic map updates. This provides the advantage that all components of the AV that rely on the map receive the same and accurate updates in a timely manner (e.g., in real-time or near real-time).

The term “vehicle” refers to any moving form of conveyance that is capable of carrying either one or more human occupants and/or cargo and is powered by any form of energy. The term “vehicle” includes, but is not limited to, cars, trucks, vans, trains, autonomous vehicles, aircraft, aerial drones and the like. An “autonomous vehicle” (or “AV”) is a vehicle having a processor, programming instructions and drivetrain components that are controllable by the processor without requiring a human operator. An autonomous vehicle may be fully autonomous in that it does not require a human operator for most or all driving conditions and functions, or it may be semi-autonomous in that a human operator may be required in certain conditions or for certain operations, or that a human operator may override the vehicle's autonomous system and may take control of the vehicle.

Notably, the present solution is being described herein in the context of an autonomous vehicle. However, the present solution is not limited to autonomous vehicle applications. The present solution may be used in other applications such as robotic applications, radar system applications, metric applications, and/or system performance applications.

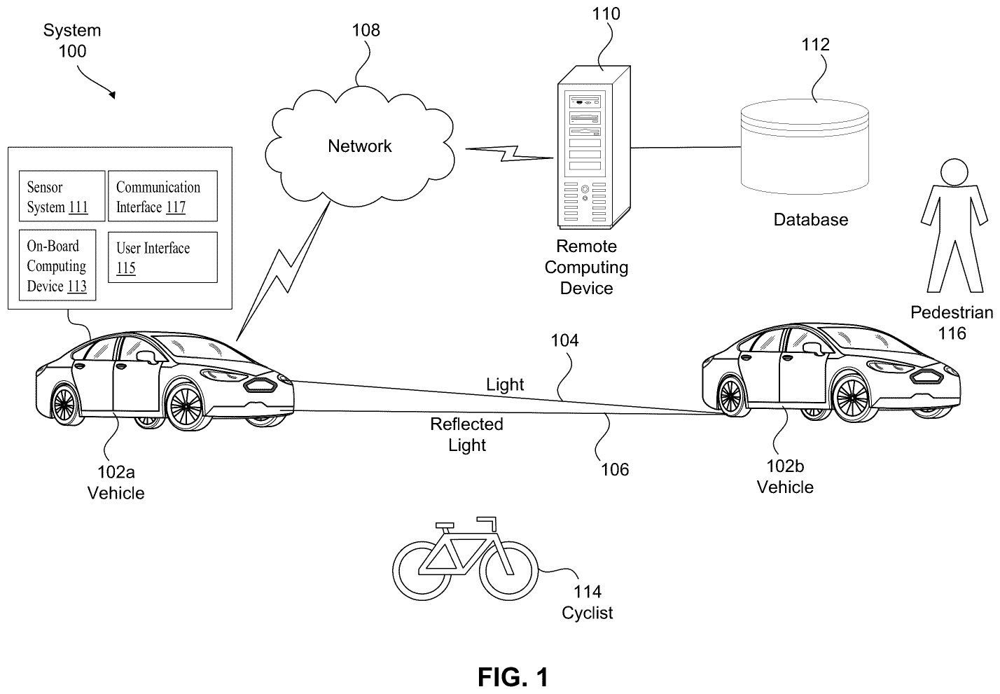

FIG. 1 illustrates an exemplary autonomous vehicle system 100, in accordance with aspects of the disclosure. System 100 comprises a vehicle 102a that is traveling along a road in a semi-autonomous or autonomous manner. Vehicle 102a is also referred to herein as AV 102a. AV 102a can include, but is not limited to, a land vehicle (as shown in FIG. 1), an aircraft, or a watercraft.

AV 102a is generally configured to detect objects 102b, 114, 116 in proximity thereto. The objects can include, but are not limited to, a vehicle 102b, cyclist 114 (such as a rider of a bicycle, electric scooter, motorcycle, or the like) and/or a pedestrian 116.

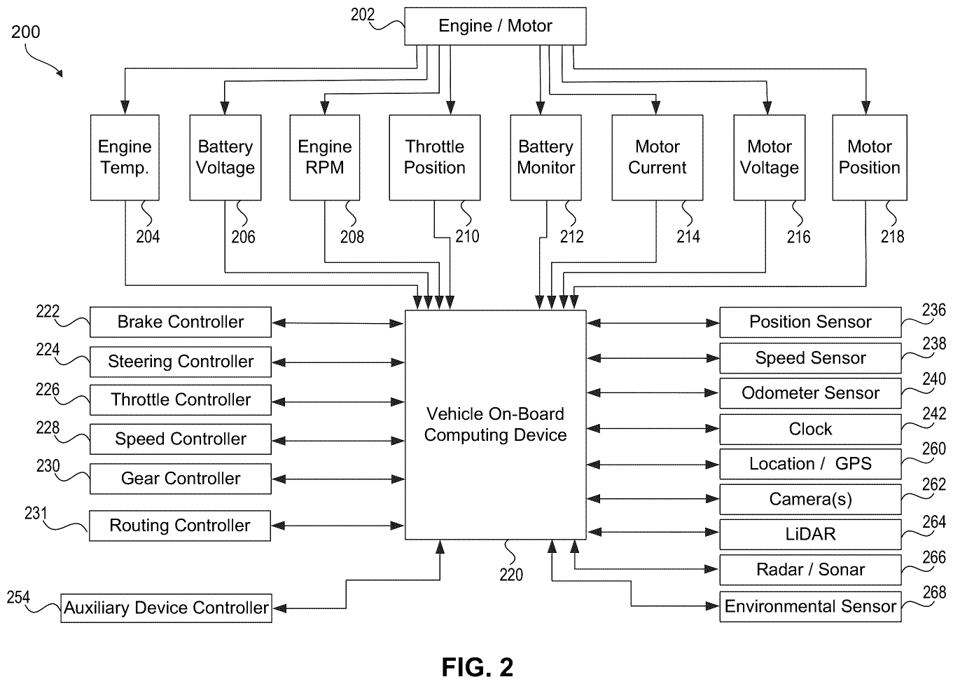

As illustrated in FIG. 1, the AV 102a may include a sensor system 111, an on-board computing device 113, a communications interface 117, and a user interface 115. Autonomous vehicle 101 may further include certain components (as illustrated, for example, in FIG. 2) included in vehicles, which may be controlled by the on-board computing device 113 using a variety of communication signals and/or commands, such as, for example, acceleration signals or commands, deceleration signals or commands, steering signals or commands, braking signals or commands, etc.

The sensor system 111 may include one or more sensors that are coupled to and/or are included within the AV 102a, as illustrated in FIG. 2. For example, such sensors may include, without limitation, a LiDAR system, a radio detection and ranging (RADAR) system, a laser detection and ranging (LADAR) system, a sound navigation and ranging (SONAR) system, one or more cameras (e.g., visible spectrum cameras, infrared cameras, etc.), temperature sensors, position sensors (e.g., global positioning system (GPS), etc.), location sensors, fuel sensors, motion sensors (e.g., inertial measurement units (IMU), etc.), humidity sensors, occupancy sensors, or the like. The sensor data can include information that describes the location of objects within the surrounding environment of the AV 102a, information about the environment itself, information about the motion of the AV 102a, information about a route of the vehicle, or the like. As AV 102a travels over a surface, at least some of the sensors may collect data pertaining to the surface.

As will be described in greater detail, AV 102a may be configured with a LiDAR system, e.g., LiDAR system 264 of FIG. 2. The LiDAR system may be configured to transmit a light pulse 104 to detect objects located within a distance or range of distances of AV 102a. Light pulse 104 may be incident on one or more objects (e.g., AV 102b) and be reflected back to the LiDAR system. Reflected light pulse 106 incident on the LiDAR system may be processed to determine a distance of that object to AV 102a. The reflected light pulse may be detected using, in some embodiments, a photodetector or array of photodetectors positioned and configured to receive the light reflected back into the LiDAR system. LiDAR information, such as detected object data, is communicated from the LiDAR system to an on-board computing device, e.g., on-board computing device 220 of FIG. 2. The AV 102a may also communicate LiDAR data to a remote computing device 110 (e.g., cloud processing system) over communications network 108. Remote computing device 110 may be configured with one or more servers to process one or more processes of the technology described herein. Remote computing device 110 may also be configured to communicate data/instructions to/from AV 102a over network 108, to/from server(s) and/or database(s) 112.

It should be noted that the LiDAR systems for collecting data pertaining to the surface may be included in systems other than the AV 102a such as, without limitation, other vehicles (autonomous or driven), robots, satellites, etc.

Network 108 may include one or more wired or wireless networks. For example, the network 108 may include a cellular network (e.g., a long-term evolution (LTE) network, a code division multiple access (CDMA) network, a 3G network, a 4G network, a 5G network, another type of next generation network, etc.). The network may also include a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or the like, and/or a combination of these or other types of networks.

AV 102a may retrieve, receive, display, and edit information generated from a local application or delivered via network 108 from database 112. Database 112 may be configured to store and supply raw data, indexed data, structured data, map data, program instructions or other configurations as is known.

The communications interface 117 may be configured to allow communication between AV 102a and external systems, such as, for example, external devices, sensors, other vehicles, servers, data stores, databases etc. The communications interface 117 may utilize any now or hereafter known protocols, protection schemes, encodings, formats, packaging, etc. such as, without limitation, Wi-Fi, an infrared link, Bluetooth, etc. The user interface 115 may be part of peripheral devices implemented within the AV 102a including, for example, a keyboard, a touch screen display device, a microphone, and a speaker, etc.

FIG. 2 illustrates an exemplary system architecture 200 for a vehicle, in accordance with aspects of the disclosure. Vehicles 102a and/or 102b of FIG. 1 can have the same or similar system architecture as that shown in FIG. 2. Thus, the following discussion of system architecture 200 is sufficient for understanding vehicle(s) 102a, 102b of FIG. 1. However, other types of vehicles are considered within the scope of the technology described herein and may contain more or less elements as described in association with FIG. 2. As a non-limiting example, an airborne vehicle may exclude brake or gear controllers, but may include an altitude sensor. In another non-limiting example, a water-based vehicle may include a depth sensor. One skilled in the art will appreciate that other propulsion systems, sensors and controllers may be included based on a type of vehicle, as is known.

As shown in FIG. 2, system architecture 200 includes an engine or motor 202 and various sensors 204-218 for measuring various parameters of the vehicle. In gas-powered or hybrid vehicles having a fuel-powered engine, the sensors may include, for example, an engine temperature sensor 204, a battery voltage sensor 206, an engine Rotations Per Minute (“RPM”) sensor 208, and a throttle position sensor 210. If the vehicle is an electric or hybrid vehicle, then the vehicle may have an electric motor, and accordingly includes sensors such as a battery monitoring system 212 (to measure current, voltage and/or temperature of the battery), motor current 214 and voltage 216 sensors, and motor position sensors 218 such as resolvers and encoders.

Operational parameter sensors that are common to both types of vehicles include, for example: a position sensor 236 such as an accelerometer, gyroscope and/or inertial measurement unit; a speed sensor 238; and an odometer sensor 240. The vehicle also may have a clock 242 that the system uses to determine vehicle time during operation. The clock 242 may be encoded into the vehicle on-board computing device, it may be a separate device, or multiple clocks may be available.

The vehicle also includes various sensors that operate to gather information about the environment in which the vehicle is traveling. These sensors may include, for example: a location sensor 260 (e.g., a Global Positioning System (“GPS”) device); object detection sensors such as one or more cameras 262; a LiDAR system 264; and/or a radar and/or a sonar system 266. The sensors also may include environmental sensors 268 such as a precipitation sensor and/or ambient temperature sensor. The object detection sensors may enable the vehicle to detect objects that are within a given distance range of the vehicle 200 in any direction, while the environmental sensors collect data about environmental conditions within the vehicle's area of travel.

During operations, information is communicated from the sensors to a vehicle on-board computing device 220. The on-board computing device 220 may be implemented using the computer system of FIG. 15. The vehicle on-board computing device 220 analyzes the data captured by the sensors and optionally controls operations of the vehicle based on results of the analysis. For example, the vehicle on-board computing device 220 may control: braking via a brake controller 222; direction via a steering controller 224; speed and acceleration via a throttle controller 226 (in a gas-powered vehicle) or a motor speed controller 228 (such as a current level controller in an electric vehicle); a differential gear controller 230 (in vehicles with transmissions); and/or other controllers. Auxiliary device controller 254 may be configured to control one or more auxiliary devices, such as testing systems, auxiliary sensors, mobile devices transported by the vehicle, etc.

Geographic location information may be communicated from the location sensor 260 to the on-board computing device 220, which may then access a map of the environment that corresponds to the location information to determine known fixed features of the environment such as streets, buildings, stop signs and/or stop/go signals. Captured images from the cameras 262 and/or object detection information captured from sensors such as LiDAR system 264 is communicated from those sensors) to the on-board computing device 220. The object detection information and/or captured images are processed by the on-board computing device 220 to detect objects in proximity to the vehicle 200. Any known or to be known technique for making an object detection based on sensor data and/or captured images can be used in the embodiments disclosed in this document.

LiDAR information is communicated from LiDAR system 264 to the on-board computing device 220. Additionally, captured images are communicated from the camera(s) 262 to the vehicle on-board computing device 220. The LiDAR information and/or captured images are processed by the vehicle on-board computing device 220 to detect objects in proximity to the vehicle 200. The manner in which the object detections are made by the vehicle on-board computing device 220 includes such capabilities detailed in this disclosure.

The on-board computing device 220 may include and/or may be in communication with a routing controller 231 that generates a navigation route from a start position to a destination position for an autonomous vehicle. The routing controller 231 may access a map data store to identify possible routes and road segments that a vehicle can travel on to get from the start position to the destination position. The routing controller 231 may score the possible routes and identify a preferred route to reach the destination. For example, the routing controller 231 may generate a navigation route that minimizes Euclidean distance traveled or other cost function during the route, and may further access the traffic information and/or estimates that can affect an amount of time it will take to travel on a particular route. Depending on implementation, the routing controller 231 may generate one or more routes using various routing methods, such as Dijkstra's algorithm, Bellman-Ford algorithm, or other algorithms. The routing controller 231 may also use the traffic information to generate a navigation route that reflects expected conditions of the route (e.g., current day of the week or current time of day, etc.), such that a route generated for travel during rush-hour may differ from a route generated for travel late at night. The routing controller 231 may also generate more than one navigation route to a destination and send more than one of these navigation routes to a user for selection by the user from among various possible routes.

In various embodiments, the on-board computing device 220 may determine perception information of the surrounding environment of the AV 102a. Based on the sensor data provided by one or more sensors and location information that is obtained, the on-board computing device 220 may determine perception information of the surrounding environment of the AV 102a. The perception information may represent what an ordinary driver would perceive in the surrounding environment of a vehicle. The perception data may include information relating to one or more objects in the environment of the AV 102a. For example, the on-board computing device 220 may process sensor data (e.g., LiDAR or RADAR data, camera images, etc.) in order to identify objects and/or features in the environment of AV 102a. The objects may include traffic signals, road way boundaries, other vehicles, pedestrians, and/or obstacles, etc. The on-board computing device 220 may use any now or hereafter known object recognition algorithms, video tracking algorithms, and computer vision algorithms (e.g., track objects frame-to-frame iteratively over a number of time periods) to determine the perception.

In some embodiments, the on-board computing device 220 may also determine, for one or more identified objects in the environment, the current state of the object. The state information may include, without limitation, for each object: current location; current speed and/or acceleration, current heading; current pose; current shape, size, or footprint; type (e.g., vehicle vs. pedestrian vs. bicycle vs. static object or obstacle); and/or other state information.

The on-board computing device 220 may perform one or more prediction and/or forecasting operations. For example, the on-board computing device 220 may predict future locations, trajectories, and/or actions of one or more objects. For example, the on-board computing device 220 may predict the future locations, trajectories, and/or actions of the objects based at least in part on perception information (e.g., the state data for each object comprising an estimated shape and pose determined as discussed below), location information, sensor data, and/or any other data that describes the past and/or current state of the objects, the AV 102a, the surrounding environment, and/or their relationship(s). For example, if an object is a vehicle and the current driving environment includes an intersection, the on-board computing device 220 may predict whether the object will likely move straight forward or make a turn. If the perception data indicates that the intersection has no traffic light, the on-board computing device 220 may also predict whether the vehicle may have to fully stop prior to enter the intersection.

In various embodiments, the on-board computing device 220 may determine a motion plan for the autonomous vehicle. For example, the on-board computing device 220 may determine a motion plan for the autonomous vehicle based on the perception data and/or the prediction data. Specifically, given predictions about the future locations of proximate objects and other perception data, the on-board computing device 220 can determine a motion plan for the AV 102a that best navigates the autonomous vehicle relative to the objects at their future locations.

In some embodiments, the on-board computing device 220 may receive predictions and make a decision regarding how to handle objects and/or actors in the environment of the AV 102a. For example, for a particular actor (e.g., a vehicle with a given speed, direction, turning angle, etc.), the on-board computing device 220 decides whether to overtake, yield, stop, and/or pass based on, for example, traffic conditions, map data, state of the autonomous vehicle, etc. Furthermore, the on-board computing device 220 also plans a path for the AV 102a to travel on a given route, as well as driving parameters (e.g., distance, speed, and/or turning angle). That is, for a given object, the on-board computing device 220 decides what to do with the object and determines how to do it. For example, for a given object, the on-board computing device 220 may decide to pass the object and may determine whether to pass on the left side or right side of the object (including motion parameters such as speed). The on-board computing device 220 may also assess the risk of a collision between a detected object and the AV 102a. If the risk exceeds an acceptable threshold, it may determine whether the collision can be avoided if the autonomous vehicle follows a defined vehicle trajectory and/or implements one or more dynamically generated emergency maneuvers is performed in a pre-defined time period (e.g., N milliseconds). If the collision can be avoided, then the on-board computing device 220 may execute one or more control instructions to perform a cautious maneuver (e.g., mildly slow down, accelerate, change lane, or swerve). In contrast, if the collision cannot be avoided, then the on-board computing device 220 may execute one or more control instructions for execution of an emergency maneuver (e.g., brake and/or change direction of travel).

As discussed above, planning and control data regarding the movement of the autonomous vehicle is generated for execution. The on-board computing device 220 may, for example, control braking via a brake controller; direction via a steering controller; speed and acceleration via a throttle controller (in a gas-powered vehicle) or a motor speed controller (such as a current level controller in an electric vehicle); a differential gear controller (in vehicles with transmissions); and/or other controllers.

In some embodiments, the multimodal approach may be used to identify For example, red, green, blue (RGB) values may be used in addition to the LiDAR intensities to identify road markings. Data from each modality may be processed separately. An artificial intelligence (AI) model (e.g., deep learning model) may be used to estimate changes in road markings by receiving data from the modalities as inputs. In some aspects, the AI model may be based on a Siamese network that learns to compare data generated on-board with data computed offline. In some aspects, the AI model may comprise an off-board model and an on-board model for road marking segmentation. The changes are detected based on the intersection over union (IoU) between a first segmentation and a second segmentation generated by the off-board model and the on-board model, respectively.

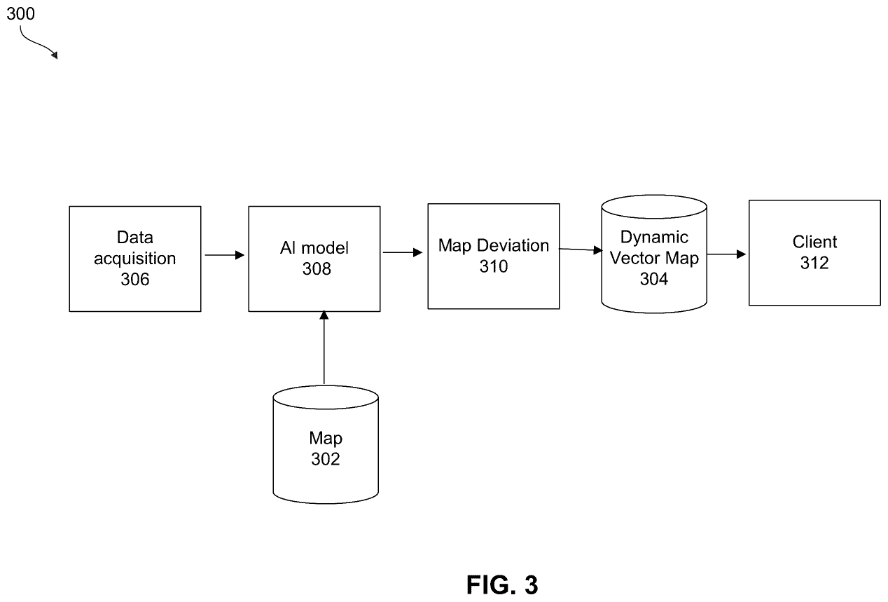

FIG. 3 is a control flow of a system 300 for detecting and handling changes in road markings, in accordance with aspects of the disclosure. Certain components of the system 300 may be embodied in processor hardware and computer-readable programming instructions that are part of the AV's on board computing system (e.g., on-board computing device 113 of FIG. 1).

In some embodiments, the control flow of system 300 may start by acquiring data for processing using a data acquisition module 306. Data acquisition module 306 may acquire data from a plurality of sensor modalities. Data acquisition module 306 may acquire data from a LiDAR sensor (e.g., LiDAR sweep from LiDAR system 264 of FIG. 2) and an image capture device (e.g., camera 262 of FIG. 2). In addition, data acquisition module 306 may receive data from a long-range LiDAR sensor and from a near-field LiDAR sensor. The data may be acquired during the operation of the AV. Data from the LiDAR sensor may include a LiDAR intensity raster. The LiDAR intensity raster is used for the on-board and off-board (offline) detection of the road markings. Data from the image capture device may include a RGB bird's eye view raster that may be used in the on-board and off-board detection.

An AI model 308 may receive data from data acquisition module 306. AI model 308 may also retrieve data from a base map 302. For example, AI model 308 may retrieve a region of interest (ROI) layer from base map 302 for the on-board detection of the road marking. In addition, a vector map may be retrieved from base map 302. AI model 308 may also acquire existing semantic predictions. Semantic predictions may obtained from an AI module that generates semantic labels from captured images (e.g., from camera 262 of FIG. 2). AI model 308 may be configured to differentiate road markings from a road surface (e.g., asphalt).

In some embodiments, AI model 308 may be based on a Siamese network. The Siamese network may be training with a triplet loss to learn to generate feature embedding that have large distance for patches that do not match and low distance for patches that match. A contrastive loss may be defined as:

$$L ( {x}_{1} , {x}_{2} , l ) = \{ \begin{matrix}{‖ f ( {x}_{1} ) - f ( {x}_{2} ) ‖}_{2} & l = 1 \\ max ( 0 , μ - {‖ f ( {x}_{1} ) - f ( {x}_{2} ) ‖}_{x} ) & l = - 1\end{matrix}$$

where μ is an arbitrarily set margin, x represents the input, f represents the features given as output from the network, and l represents a label for the patch pair. For negative pairs, l=−1 is used. For positive pairs, l=1 is used. The objective of the training is for L to be low if x₁ and x₂ are a positive pair.

In some embodiments, AI model 308 may be a shallow network that is memory efficient and can run in real time. In some aspects, the Siamese network is trained using triplets of data with an anchor (obtained from a tile from map 302), a positive example, and a negative example. In some aspects, the positive example may be obtained from the anchor by applying an augmentation technique. Thus, a large training dataset may be automatically generated. The negative example may be synthesized using the augmentation technique. The negative example may be also obtained from a different tile or the same tile but at a different location. The Siamese network is configured to work in patches until a whole area corresponding to the tile map is processed.

In some embodiments, AI model 308 may be based on a road marking segmentation network. In some aspects, the road marking segmentation network can have a U-Net architecture that comprises an encoding path and a decoding path. In some aspects, AI model 308 may include two separate models: an offline model and an on-board model.

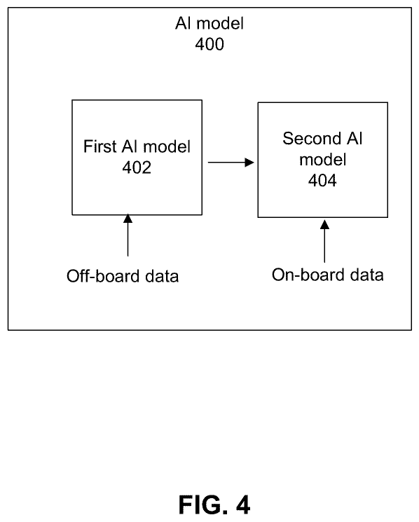

FIG. 4 is a schematic that illustrates an AI model 400, in accordance with aspects of the disclosure. AI model 400 may include a first AI model 402 and a second AI model 404. First AI model 402 may be an offline model that processes the off-board data. Off-board data may include data collected by a plurality of A Vs. Off-board data may include a point cloud of the trajectory collected by one or more LiDAR systems, with a range of reflectance associated with each point. The off-board data may also include one or more corresponding camera images for the trajectory. Thus, the off-board may be denser then the on-board data and may generate more accurate ground truth data compared to the on-board data. Second AI model 404 may be an on-board model that processes the on-board data. In some aspects, first AI model 402 may be trained independently from second AI model 404. In some aspects, an output of first AI model 402 may be used to train second AI model 404. Since first AI model 402 and second AI model 404 can be independent from each other, second AI model 404 may be a relatively small network that can generate high accuracy road markings on board. First AI model 404 may be a version of the on-board model or network but with more layers and inputs (e.g., use additional sensor modalities) for increased accuracy. Second AI model 404 may receive on-board data collected while the AV is in operation and traversing a trajectory.

In some embodiments, AI model 400 may be trained by generating weakly supervised signals using conditional random fields (CRFs). AI model may output an estimate or a probability of what is indicative of a road marking. Each pixel or point may be classified as either road marking or non-road marking. Annotations may be performed manually or automatically. For example, if the output from the AI model has an error rate above a threshold, then the annotations may be reviewed manually. Thus, for each portion of the trajectory the tile map may be retrieved and the annotations are determined. The annotations or ground truth data are used to train second AI model 404.

In some embodiments, the multimodal approach described herein provides more robust results under different lighting and weather conditions compared to techniques using data from a single sensor. The data from multiple modal sensors are complementary. And, the AI model may be trained based on correlation between color from the images (e.g., asphalt is dark while road markings are usually marked with light colors) and intensity of the point from the LiDAR sensor (i.e., higher measured intensity from road marking compared to the non-painted surfaces such as asphalt or concrete). In some embodiments, AI model 400 may receive additional inputs. For example, AI model 400 may also receive semantic labels from other modules or tasks of the AV. AI model 400 may be trained using the semantic labels for the data points. Semantic labeling may add information to the LiDAR points (e.g., labeling the points as a road, a sidewalk, a road marking, vegetation, a building, or the like).

In some embodiments, data collected using a first LiDAR system may be converted or calibrated. For example, a histogram matching to convert intensities from the first LiDAR system to correspond to a second LiDAR system. First LiDAR system and second LiDAR system may be based on different LiDAR technology (e.g., the systems may have different types of detectors). In some aspects, a style transfer model may be applied to the training data. For example, the model may transfer data from a first source (e.g., first LiDAR system) to an intermediate domain that facilitates the adaptation of the AI model. Thus, the AI model is robust to sensor changes.

The AI model may be tested using a small test set for ablation studies to settle on the details of the AI model. A first evaluation may be performed on a small portion of the map. The results may be compared with the baseline method (i.e., comparing road markings detected using one sensor modality). The process may be repeated for a larger portion of the map.

Referring back to FIG. 3, a map deviation task 310 may determine whether there is a change in the road markings based on an output from AI model 308. Map deviation task 310 may propagate a map update to all clients 312 of the map. Clients may refer to software and/or hardware components of the AV that utilize the updated map to operate the AV (e.g., a prediction task, a motion planning task). All clients of the map receive the exact same updates. In some aspects, the updates may be performed via application programming interfaces (APIs). In some aspects, map updates may be communicated to client 312 via a shared memory. The unchanged map is not copied into the dynamic vector cache. A dynamic vector map 304 may be sent to all clients that rely on the map. In addition, the updates are received with minimal latency (e.g., in real time or near real time). In some aspects, a map interface associated with map 302 and dynamic vector map 304 provides functions to query for road markings and changes in the road marking for a given trajectory (e.g., lane segment). A lane segment may refer to a segment of a road where the AVs and other vehicles move in a single-file fashion in a single direction. Multiple lane segments may occupy the same physical space (e.g., in an intersection). For example, a prediction module may query dynamic vector map 304 and map 302 to determine whether there is road marking associated with the lane segment (e.g., right turn only).

The modules described with respect to FIG. 3 may be implemented as instructions stored on a non-transitory computer readable medium to be executed by one or more computing units such as a processor, a special purpose computer, an integrated circuit, integrated circuit cores, or a combination thereof. The non-transitory computer readable medium may be implemented with any number of memory units/components, such as a volatile memory, a nonvolatile memory, an internal memory, an external memory, or a combination thereof. The non-transitory computer readable medium may be integrated as a part of the system 300 or installed as a removable portion of the system 300.

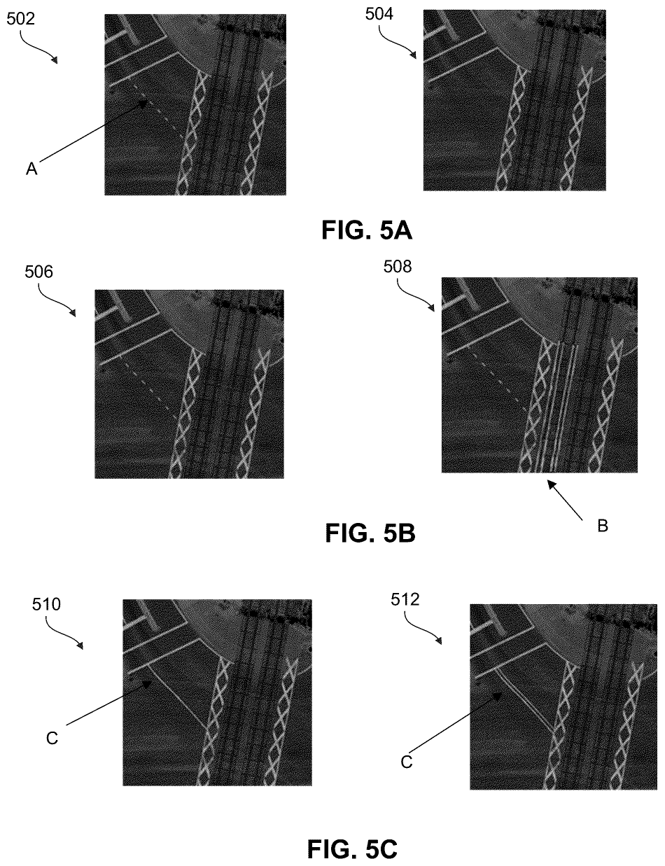

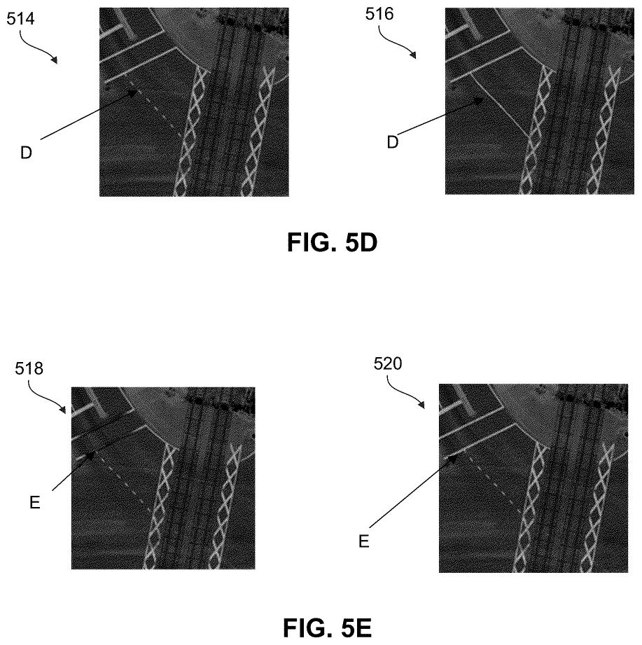

System 300 may detect many changes in the road markings. Some changes in the road markings may trigger a map update. Other changes does not trigger a map update. For example, a new road marking (i.e., does not appear in the base map) triggers a map update. Similarly, a road marking that does no longer exist on the road triggers the map update or other changes that may affect the behavior of the AV. For example, lane markings that may divide a road may indicate whether the AV may pass another vehicle or whether such maneuver is not allowed (no passing). Other changes may not need to trigger a map update. For example, repainting a road marking may not trigger a map update. In some cases, changes in the road marking representation may not trigger the map update (e.g., change from a solid line to a double line). FIGS. 5A-5D show exemplary changes in road markings. In some embodiments, system 300 may assign a category for the change. Map deviation task 310 may trigger a map update for predetermined categories (e.g., new road marking, removed road marking).

FIG. 5A is a schematic that illustrates a change in the road markings, in accordance with aspects of the disclosure. Schematic 502 illustrates the road markings in the base map. Schematic 504 illustrates the road marking obtained from the AI model. Road marking A in schematic 502 does appear in schematic 504 but it is degraded. Such changes may not trigger a dynamic map update.

FIG. 5B is a schematic that illustrates a change in the road markings, in accordance with aspects of the disclosure. Schematic 506 illustrates the road markings in the base map. Schematic 508 illustrates the road marking obtained from the AI model. Road marking B appears in schematic 508 and is not present in schematic 506. This change may trigger a dynamic map update.

FIG. 5C is a schematic that illustrates a change in the road markings, in accordance with aspects of the disclosure. Schematic 510 illustrates the road markings in the base map. Schematic 512 illustrates the road marking obtained from the AI model. Road marking C in schematic 510 does appear in schematic 512 with a different lane representation (i.e., attribute).

FIG. 5D is a schematic that illustrates a change in the road markings, in accordance with aspects of the disclosure. Schematic 514 illustrates the road markings in the base map. Schematic 516 illustrates the road marking obtained from the AI model. Road marking D in schematic 514 does appear in schematic 516 with a different lane representation (i.e., attribute). The change may or may not trigger a dynamic map update based on whether the change in representation affects the behavior of the AV.

FIG. 5E is a schematic that illustrates a change in the road markings, in accordance with aspects of the disclosure. Schematic 518 illustrates the road markings in the base map. Schematic 520 illustrates the road marking obtained from the AI model. Road marking E in schematic 518 does appear in schematic 520 but appears to be repainted. In some aspects, this change may not trigger a map update.

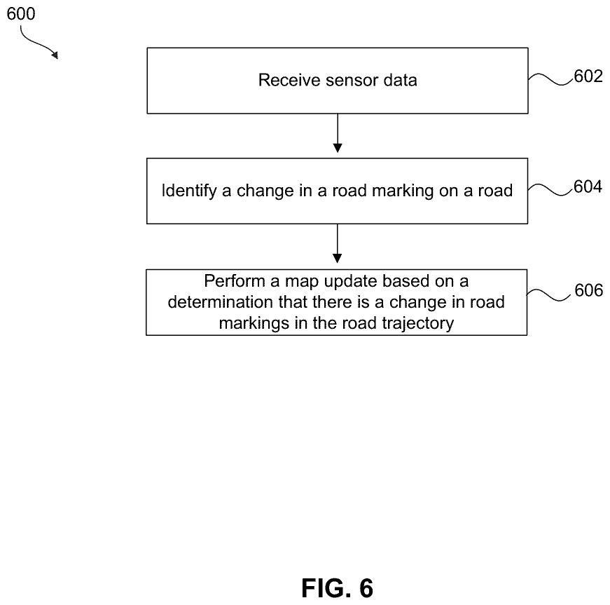

FIG. 6 is a flowchart for a method 600 for detecting and handling changes in road markings, in accordance with aspects of the disclosure.

At 602, sensor data may be received from a plurality of sensors. For example, vehicle on-board computing device 220 may receive data from LiDAR system 264 and camera 262. The data may also include data from a near-field LiDAR and from a long-range LiDAR.

At 604, a change in a road marking is identified based on the sensor data. For example, AI model 308 may be used to identify whether there is a change in the road markings.

At 606, a map update is performed based on a determination that there is a change in the road markings in the road trajectory. In some aspects, the map update is performed when the change in the road markings may affect the behavior of the vehicle. Thus, the map update may be performed in response to a determination that the change belongs to predetermined categories or classifications. In some aspects, the map is updated when the change is permanent. For example, an operator may review the detected change to determine whether the change is permanent (e.g., not associated with temporary road resurfacing).

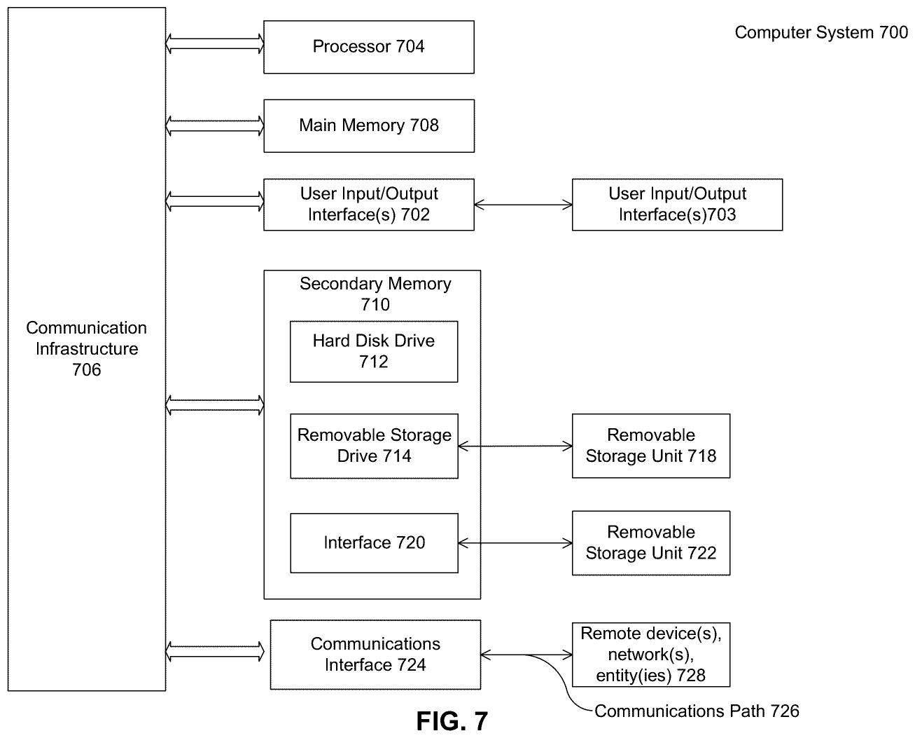

Various embodiments can be implemented, for example, using one or more computer systems, such as computer system 700 shown in FIG. 7. Computer system 700 can be any computer capable of performing the functions described herein.

Computer system 700 includes one or more processors (also called central processing units, or CPUs), such as a processor 704. Processor 704 is connected to a communication infrastructure or bus 706.

One or more processors 704 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 also includes user input/output device(s) 703, such as monitors, keyboards, pointing devices, etc., that communicate with communication infrastructure or bus 706 through user input/output interface(s) 702.

Computer system 700 also includes a main or primary memory 708, such as random access memory (RAM). Main memory 708 may include one or more levels of cache. Main memory 708 has stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 includes a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 reads from and/or writes to removable storage unit 718 in a well-known manner.

According to an exemplary embodiment, secondary memory 710 may include other means, instrumentalities or other approaches for allowing computer programs and/or other instructions and/or data to be accessed by computer system 700. Such means, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 enables computer system 700 to communicate and interact with any combination of remote devices, remote networks, remote entities, etc. (individually and collectively referenced by reference number 728). For example, communication interface 724 may allow computer system 700 to communicate with remote devices 728 over communications path 726, which may be wired and/or wireless, and which may include any combination of LANs, WANs, the Internet, etc. Control logic and/or data may be transmitted to and from computer system 700 via communication path 726.

In an embodiment, a tangible, non-transitory apparatus or article of manufacture comprising a tangible, non-transitory computer useable or readable medium having control logic (software) stored thereon is also referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method, comprising:
identifying, by one or more computing devices, a road marking in a road trajectory of a vehicle using an artificial intelligence (AI) model and sensor data from a sensor of the vehicle, wherein the sensor data includes two or more sensor modalities; and
performing, by the one or more computing devices, a map update based on a determination that there is a change in road markings in the road trajectory, wherein the determination is based on at least on-board data generated when the vehicle is traversing the road trajectory and off-board data generated using stored data.

2. The method of claim 1, further comprising:
detecting, by the one or more computing devices, the change based on an intersection over union (IoU) between a first road marking segmentation based on the off-board data and a second road marking segmentation based on the on-board data.

3. The method of claim 1, wherein the AI model is a Siamese network, the method further comprising:
detecting, by the one or more computing devices, the change based on a comparison by the Siamese network between the on-board data and the off-board data.

4. The method of claim 1, wherein the AI model comprises a first model and a second model, the method further comprising:
obtaining, by the one or more computing devices, a first road marking segmentation using the first model based on the off-board data; and
obtaining, by the one or more computing devices, a second road marking segmentation using the second model based on the on-board data.

5. The method of claim 4, further comprising:
training, by the one or more computing devices, the first model using a conditional random field (CRF) technique using the off-board data; and
training, by the one or more computing devices, the second model using ground truth data obtained from the first model.

6. The method of claim 1, further comprising:
classifying, by the one or more computing devices, the change based on detection of a degraded road marking, a new road marking, or a change in a lane representation.

7. The method of claim 1, wherein the sensor data comprises a LiDAR sweep and an image.

8. The method of claim 1, wherein the performing further comprises:
altering, by the one or more computing devices, a motion plan of the vehicle based on the change.

9. The method of claim 1, wherein the performing further comprises:
updating, by the one or more computing devices, a base map based on a determination that the change is permanent; and
propagating, by the one or more computing devices, an instruction to one or more vehicles to apply an update to the base map.

10. A system, comprising:
a memory; and
at least one processor coupled to the memory and configured to perform operations comprising:
identifying a road marking in a road trajectory of a vehicle using an artificial intelligence (AI) model and sensor data from a sensor of the vehicle, wherein the sensor data includes two or more sensor modalities; and
performing a map update based on a determination that there is a change in road markings in the road trajectory, wherein the determination is based on at least on-board data generated when the vehicle is traversing the road trajectory and off-board data generated using stored data.

11. The system of claim 10, the operations further comprising:
detecting the change based on an intersection over union (IoU) between a first road marking segmentation based on the off-board data and a second road marking segmentation based on the on-onboard data.

12. The system of claim 10, wherein the AI model is a Siamese network, the operations further comprising:
detecting the change based on a comparison by the Siamese network between the on-board data and the off-board data.

13. The system of claim 10, wherein the AI model comprises a first model and a second model, and the operations further comprising:
obtaining a first road marking segmentation using the first model based on the off-board data; and
obtaining a second road marking segmentation using the second model based on the on-board data.

14. The system of claim 13, the operations further comprising:
training the first model using a conditional random field (CRF) technique using the off-board data; and
training the second model using ground truth data obtained from the first model.

15. The system of claim 10, the operations further comprising:
classifying the change based on a detection of a degraded road marking, a new road marking, or a change in a lane representation.

16. The system of claim 10, wherein the sensor data comprises a LiDAR sweep and an image.

17. The system of claim 10, the operations further comprising:
altering a motion plan of the vehicle based on the change.

18. The system of claim 11, the operations further comprising:
updating a base map based on a determination that the change is permanent; and
propagating an instruction to apply an update to the base map to one or more vehicles.

19. A non-transitory computer-readable medium having instructions stored thereon that, when executed by at least one computing device, cause the at least one computing device to perform operations comprising:
identifying a road marking in a road trajectory of a vehicle using an artificial intelligence (AI) model and sensor data from a sensor of the vehicle, wherein the sensor data includes two or more sensor modalities; and
performing a map update based on a determination that there is a change in road markings in the road trajectory, wherein the determination is based on at least on-board data generated when the vehicle is traversing the road trajectory and off-board data generated using stored data.

20. The non-transitory computer-readable medium of claim 19, the operations further comprising:
detecting the change based on an intersection over union (IoU) between a first road marking segmentation based on the off-board data and a second road marking segmentation based on the on-board data.
